(19) United States
(12) Patent Application Publication
(10) Pub. No.: US 2009/0083333 A1
(43) Pub. Date: Mar. 26, 2009

(54) DESIGN SUPPORT SYSTEM

(76) Inventors: Noriaki YAMAMOTO, Zushi (JP); Tomoyo Aoyagi, Tokyo (JP)

Correspondence Address: MATTINGLY, STANGER, MALUR & BRUNDIDGE, P.C., 1800 DIAGONAL ROAD, SUITE 370, ALEXANDRIA, VA, 22314, US

(21) Appl. No.: 12/236,890

(22) Filed: Sep. 24, 2008

(30) Foreign Application Priority Data
Sep. 25, 2007 (JP) 2007-246483

(51) Int. Cl. G06F 17/30

(52) U.S. Cl. 707/104.1; 707/E17.044

(57) ABSTRACT

The present invention solves the problems with the prior-art environmentally friendly design. That is, in order to achieve continual improvement, it is necessary to make a detailed evaluation based on the parts configuration. If a method of setting a basic unit for each individual part is used, a large number of process steps are required, and it is impossible to conduct accurate life cycle assessments (LCAs) frequently. The present invention provides an environmental impact assessment support and design support system incorporating a database in which information about the basic unit is associated with information about product classifications, parts classifications, and materials classifications. The system manages the information about the parts configuration and the basic unit while associating their histories of creation with each other.

### CROSS REFERENCES TO RELATED APPLICATIONS

This application relates to and claims priority from Japanese Patent Application No. 2007-246483, field on Sep. 25, 2007, the entire disclosure of which is incorporated herein by reference.

### BACKGROUND OF THE INVENTION

1. Field of the Invention

The present invention relates to techniques for supporting environmental impact assessments of product life cycles and environment-conscious designs and, more particularly, to a design support system that supports making evaluations of plural design proposals.

2. Description of the Related Art

According to ISO14040, an LCA (Life Cycle Assessment) is a technique of quantitatively organizing and analyzing resources and energies inputted (consumed and introduced) at each stage of the whole product life cycle including procurement of raw materials, manufacturing, use, recycling, and final disposal as well as data about the outputted products or environmentally unfriendly emissions (inventory analysis) and making an overall assessment of potential impacts of products on the environment using the results of the inventory analysis (impact assessment).

An LCA (Life cycle assessment) supporting software product described in pages 239-252 of a book “Business Practice of LCA” published by Japan Environmental Management Association for Industry is available as a technique for making an environmental impact assessment of a product life cycle. LCA (Life cycle assessment) is herein synonymous with environmental impact assessment. In implementing the LCA of a manufactured product, it is desired to search for certain information associated with the product but it is difficult to perform every search including a search for manufacturing of raw materials. In commercially available software products, databases have been compiled from literature data. Implementation of LCA is assisted by using the data.

For example, stored in JEMAI-LCA is a basic unit database created principally based on Japanese literature and results of research and analysis made by the developer of the software product. Meanwhile, many kinds of basic unit databases created based on the results of researches made by industry groups and research organizations chiefly in Europe are attached to SimaPro. In some examples, plural research results are stored for one basic unit name.

The basic unit database is a database in which the inventory of a single function or a single process is stored. This is described in further detail by taking an example of an inventory of cold-rolled steels at the manufacturing stage of raw materials. In a unit process where 1 kg of the material of cold-rolled steel is produced, various resources and energies such as iron ore, crude oil, coal, natural gas, and water are inputted to the unit process. Outputted environmentally unfriendly emissions include CO₂, NOₓ, SOₓ, and solid wastes that are inventory items. These amounts of consumption and amounts of emissions being inventory items form basic unit data at the stage where the material of cold-rolled steel is produced. The basic unit data is built by various sections of the life cycle stage including manufacturing of raw material, manufacturing of parts, manufacturing of finished product, use, circulation, recycling, and disposal. The basic unit provides data for inventory analysis over the whole life cycle. The basic unit data may be hereinafter referred to as LCI (life cycle inventory) data.

In implementing a life cycle assessment (LCA), it is necessary to build an exhaustive set of LCI data about manufacturing of raw materials, manufacturing of parts, and soon. In researches on life cycle assessments made by Japanese various industrial associations, building of LCI data for each unit process and for each method of manufacture regarding various products (including materials and components) are in progress (see http://www.jemai.or.jp/lcaforum/db/01_{—}05.cfm “LCA Japan Forum”). Also, in Europe, research into LCI data is in progress.

In this way, the life cycles of in-house products are assessed by utilizing LCI data obtained by research performed by a research organization or various kinds of LCI data stored in commercially available software products or by employing LCI data created by conducting research on environmental load placed when in-house manufacturing is done.

Although product designers have knowledge about materials and parts in discussing product specifications, they often have small knowledge about environmental impact assessments. Therefore, it is difficult for themselves to select appropriate data items from a database of various LCI data. In addition, it is inefficient to station evaluators dedicated for LCA.

Faced with this problem, methods for supporting identification of LCI data based on parts information identified at the stage of design from parts classification information and from LCI data accumulated in a database are disclosed in patent reference 1 (JP-A-2003-271220), patent reference 2 (JP-A-2005-332006), and patent reference 3 (JP-A-2005-38051).

In the techniques described in the above-cited patent references 1-3, selection of LCI data on a display screen by a product designer is aided by classifying materials and parts, making the classified materials and parts correspond to LCI data, storing them in a database, and displaying the LCI data based on attribute data in the database.

However, in developing and designing a single kind of products, it is customary that plural designers cooperate. If data items are selected in turn by the different designers, different LCA results arise according to the different designers. For example, in designing the product, different functions and different structural units are assigned to different designers. Furthermore, in operations other than designing, many company departments cooperate to develop products. For instance, a materials department is engaged in procurement of parts. Productivity and design departments are engaged in productivity and manufacturing operations. In this way, many departments cooperate to achieve environment-friendliness. Where individual responsible persons select LCI data at their own discretions, assessment conditions are different although the materials configuration and the parts configuration are the same. Hence, different LCA results will take place.

At the initial phase of new design, there are some portions whose detailed specifications have not been yet established. During a process where targets of required specifications of functions, costs, and environment-friendliness are determined and discussed, plural plans of parts configuration and manufacturing steps are compared and discussed. Based on such uncertain design information, it is impossible to implement LCA. Often, LCA is carried out after a detailed design has been completed.

Meanwhile, in recent years, more stringent environmental regulations have been imposed to prompt people to consider their life cycle. For example, in the European EuP (energy-using product) directive, there is a tendency that people are obliged to manage the grounds of environmentally friendly designs as well as to disclose information about the LCA results throughout the product life cycle. In order to cope with such tightening of regulations, data about environmental load at the time of manufacturing is collected from the suppliers. Alternatively, the environmental load at the captive factory is searched and unique LCI data is created. Thus, comprehensiveness of LCI data is achieved. Furthermore, the freshness of data is improved. As a result, a set of diverse data is created.

In the prior art, however, LCI data is stored in a database. During the design phase, a choice is presented on a display screen, which is assistance. However, during the design-improving process from the conceptual design phase to the detailed design phase, the method of selecting updatable LCI data by plural designers and the method of managing the results of LCA based on plural design proposals have been unsatisfactory in some respects. In order to make continual improvement that is a requirement imposed by the EuP directive, it seems that it is necessary to make detailed evaluations based on the results of assessments of parts configuration (Bill of Materials). In the conventional method of making a choice of a link of LCI data from a display screen, the burden imposed on the designers during the work is increased. Therefore, it has been impossible to perform LCA frequently at the design phase.

### SUMMARY OF THE INVENTION

It is a first object of the present invention to provide an environmental impact assessment supporting system which interrelates and manages the histories of updated information about parts configuration and updated LCI data during an environmentally friendly design process starting from a conceptual design phase.

It is a second object of the present invention to provide a design support system which manages the history of design improvements used as the basis of environmentally friendly design and which stores the history of a process starting from plural proposals and ending with an actually adopted design proposal.

To achieve the foregoing objects, one feature of the present invention provides a design support system having input means, output means, computing means, storage means, and means interfaced with a design system that designs a product. The storage means has an LCI data history storage part. The LCI data history storage part has a memory portion in which parts classifications, materials classifications, process classifications, and amounts of environmental load are defined for each life cycle stage. Identification codes, search periods, search areas, and date of creation are stored in the memory portion to identify each individual registered item. Furthermore, archival records of updates of information about the parts configuration during the design phase are stored in the memory portion. The LCI data history storage portion has means for associating and managing the archival records of both parts information and LCI data.

Another feature of the present invention provides a design support system having input means, output means, computing means, storage means, and means interfaced with a design system that designs a product. The storage means has LCI data history storage portion and a parts configuration information history storage portion. The storage portion has a department information storage part for storing information about departments of the captive factory regarding design, resources, and manufacturing or information about the department associated with designs of products. In addition, the storage portion has a company information storage part for storing information about suppliers of parts, clients to which products are delivered, and associated key manufacturing plants. Moreover, the storage portion has a parts information storage part for storing information about the specifications of parts, classifications, materials configuration, and contained substances, i.e., fundamental information about the configurations of products. Additionally, the storage portion has a step information storage part for storing information about parts and manufacturing steps for manufacturing products. The computing means includes a conversion processing portion for accepting a parts configuration tree obtained by integrating alternative plans offered by factory departments and companies and converting the tree into a parts configuration tree for assessment, a display processing portion for displaying the parts configuration tree, an LCI data registration processing portion for associating the parts configuration tree and LCI data, an environmental impact assessment processing portion for performing LCA computation based on the LCI data, and an assessment processing portion for performing calculations about the alternative plans from the results of the assessment.

A further feature of the present invention provides a design support system having input means, output means, computing means, storage means, and means interfaced with a design system that designs a product. The storage means has an LCI data history storage part, a parts configuration information history storage part, a captive factory department information storage part, a company information storage part, a parts information storage part, and step information storage part. The computing means has a conversion portion for accepting an integrated configuration tree including alternative plans, a parts configuration tree display processing portion, an LCI data registration processing portion, and an environmental impact assessment processing portion. A plan adopted during a design process is accumulated as an archival record of the parts configuration information and managed. The archival record is displayed together with the history of adoption on the configuration tree display processing portion.

According to the present invention, LCA can be carried out efficiently and quantitatively for plural design plans and in a corresponding manner to variations in design information occurring during a design improvement process and to updating of LCI data. Furthermore, it is possible to manage the basis of an environmentally friendly design by managing archival records of plan adoption together with the LCA results.

### BRIEF DESCRIPTION OF THE DRAWINGS

FIG. 1 is a diagram illustrating the configuration of a system for evaluating the environmental impacts and supporting a design according to one embodiment of the present invention;

FIG. 2 is a table illustrating an example of a set of LCI data having archival records, illustrating the embodiment of the invention;

FIG. 3 is a table depicting an example of classification-specific fundamental scenario storage part, illustrating the embodiment of the invention;

FIG. 4 is a table depicting an example of exceptional scenario storage part, illustrating the embodiment of the invention;

FIG. 5 is a schematic diagram illustrating a parts configuration associated with the table of FIG. 4;

FIG. 6 is a flowchart illustrating processing for associating BOM and LCI data used for illustration of the embodiment;

FIG. 7 is a diagram illustrating an example of a screen for accepting user's information and product information used for illustration of the embodiment;

FIG. 8 is a diagram illustrating an example of a screen for setting assessment conditions used for illustration of the embodiment;

FIG. 9 is a diagram schematically illustrating association of sets of LCI data used for illustration of the embodiment;

FIG. 10 is a table illustrating an example of classification storage part used for illustration of the embodiment;

FIG. 11 is a diagram illustrating an example of a table of two types of configuration, i.e., parts configuration and materials configuration, used for illustration of the embodiment;

FIG. 12 is a table illustrating an example of parts configuration and manufacturing process sequence used for illustration of the embodiment;

FIG. 13 is a diagram illustrating the configuration of an environmental impact assessment and design supporting system that refers to the results of registration of improvement plans of company departments according to one embodiment of the present invention; and

FIG. 14 is a diagram illustrating an example of results of assessments according to one embodiment of the invention.

### DETAILED DESCRIPTION OF THE PREFERRED EMBODIMENTS

Embodiments of the present invention are hereinafter described in detail with reference to the drawings. In the present specification, both each individual component and a unit or subassembly of parts are referred to as “parts”. For example, a part procured from a supplier is referred to as a “procured part”. A part manufactured in-house is referred to as an “in-house manufactured part”. Materials and raw materials are collectively referred to as “materials”. Each part is made of at least one material. A product is made up of at least one part. A chemical substance contained in a material is referred to as “contained substance”. These hierarchical relationships are given by “product-part-material-contained substance”. The hierarchical levels are respectively referred to as “parts configuration”, “materials configuration”, and “contained substance configuration”, respectively. In the following description, a parts configuration tree is synonymous with a parts configuration and at a level of hierarchy. An LCA (life cycle assessment) consists of an inventory analysis and an impact assessment. The impact assessment is used to multiply by coefficients for classification, normalization, and integration, for performing an assessment based on the results of the inventory analysis. In the present specification, the explanation centers on inventory analysis.

However, inventory analysis results have some common features with impact assessment results. Therefore, the inventory analysis results are described as a system for LCA, environmental impact assessment and environmentally friendly design support. Basic unit data used in inventory analysis is denoted by “LCI data”. The details have been already described.

The configuration of the environmental impact assessment and design support system according to one embodiment of the present invention is first described.

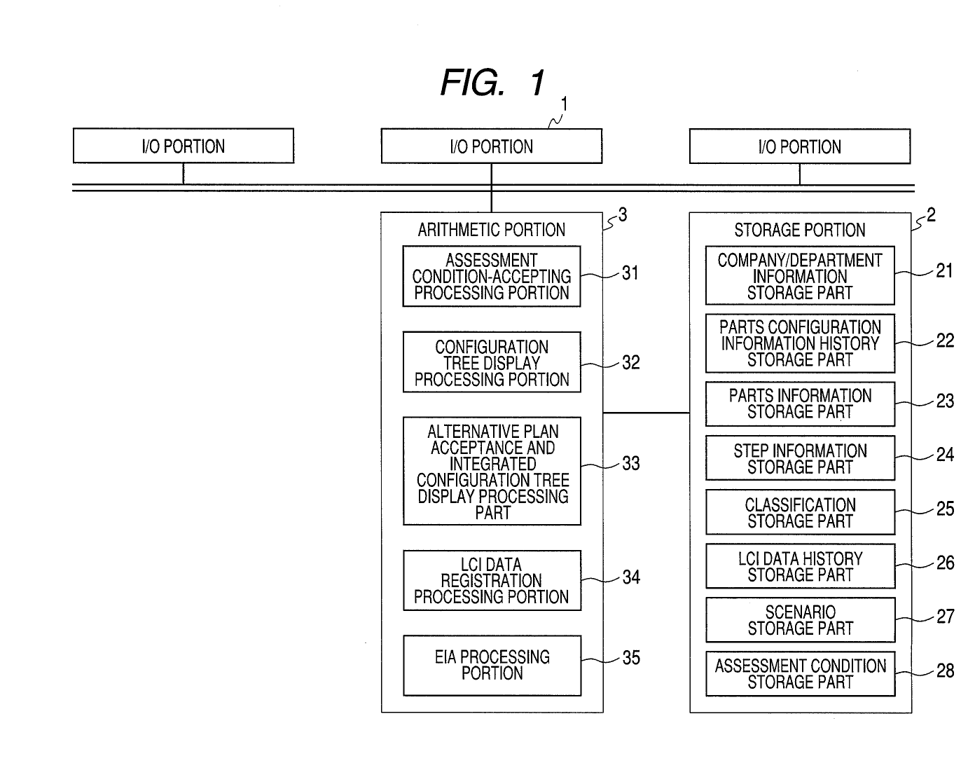

FIG. 1 schematically shows an environmental impact assessment and design support system according to one embodiment of the present invention. As shown, the environmental impact assessment and design support system according to the present embodiment has input-output portions 1, a storage portion 2, and a computing portion 3. The input-output portions 1 can manipulate the computing portion via a network, and permit cooperation between plural users.

Each input-output (I/O) portion 1 inputs and outputs data to be stored in the storage portion 2, accepts instructions from the users, and displays information for the users. Furthermore, each input-output portion 1 has means interfaced with a design system that designs products.

The storage portion 2 has a company/department information storage part 21, a parts configuration information history storage part 22, a parts information storage part 23, a step information storage part 24, a classification storage part 25, an LCI data history storage part 26, a scenario storage part 27, and an assessment condition storage part 28.

The parts configuration information includes parts structure (PS) being hierarchical information about item codes and parts numbers (Parts Numbers) being attribute information about item codes and item names. The parts configuration information is also referred to as bill of materials (BOM).

Information about companies such as parts suppliers, clients to which products are delivered, and associated key manufacturing plants is stored in the company/department information storage part 21. Also, information about the departments of the present company (e.g., information about departments such as design, materials, and manufacturing departments and responsible persons) is stored in the company/department information storage part 21.

The BOM (bill of materials) is version-managed. The information about the BOM is accumulated and stored as updated hierarchical records of the parts configuration information during a design process into the parts configuration information history storage part 22.

Parts information about products and parts constituting the products is stored in the parts information storage part 23. The parts information includes information about client names, manufacturing company names, parts serial numbers of manufacturers, parts names, and parts classification corresponding to item codes. In addition, the parts information includes information about the kinds of materials constituting the parts, masses, kinds of contained substances, amounts of the contained substances, unit costs of parts, and unit costs of materials.

Information about process flow in each life cycle stage (LCI classification) is stored in the step information storage part 24. An example of information about manufacturing stages is information about machining of parts. The information about machining of parts indicates various machining methods such as cutting, pressing, and polishing for each material kind and for each part classification, as well as machining times, and costs. In addition, information about recycling and disposal stages is similarly stored. The information about recycling and disposal stages includes information about processing and disposal methods such as recovery, crushing, recycling, and landfill for each material kind and for each part classification, as well as costs and recycling rates.

Information about allocations of materials and parts codes managed by a user, LCI classifications registered in the LCI databases, and LCI data names is stored in the classification storage part 25. In particular, the stored information is about materials classifications, parts classifications, material codes, parts codes, materials names, parts names, LCI classifications, LCI data names, and so on.

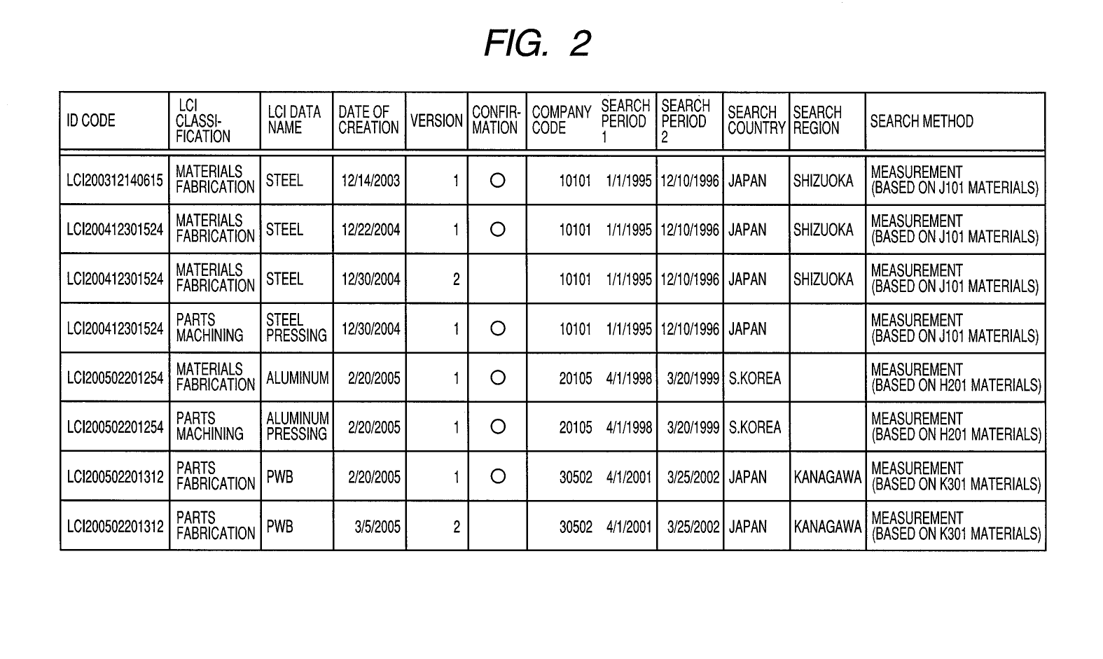

The amount of environmental load is defined for each of life cycle stages (LCI classifications) and LCI data names in the LCI data history storage part 26. To identify each unit of registration, various kinds of information including identification code, the date at which creation was made, version of the created data, company code (researcher), search period, search nation, search region, and method of search are stored. Where a new search is done under the conditions of the same LCI classification and same LCI data name, the historical management is performed while varying the identification code. Where data about a reply from a supplier or data registered during an in-house search should be amended, a registration is made using the same identification code but varied date of creation and version number. Also, the amendment history is managed. An example of a set of LCI data including archival records is shown in FIG. 2, where the column of “confirmation” shows an example in which results of data confirmed by an LCI data management department are stored (confirmation information about LCI data). As shown, data items are confirmed or not depending on different registration versions under the same LCI data name, and the resulting archival records are also stored.

Before describing the scenario storage part 27, scenarios are described. A scenario defines an interrelationship between an object to be evaluated when LCA is performed and LCI data. For example, an item code A represents iron. Regarding the “iron”, in the materials fabrication stage, LCI data about “cast iron” was associated. In the parts machining stage, LCI data about “iron casting” and “iron pressing” were associated. In the recycling stage, LCI data about “recycling of cast iron” was associated. These associating steps are referred to as a scenario.

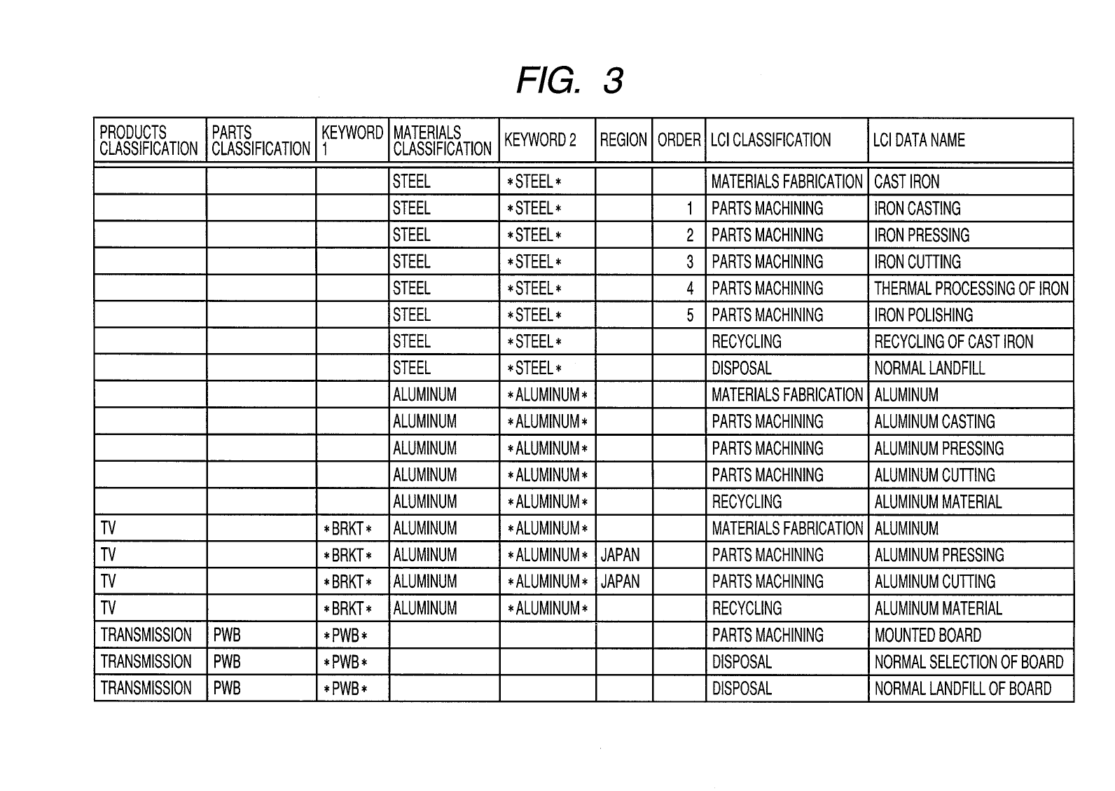

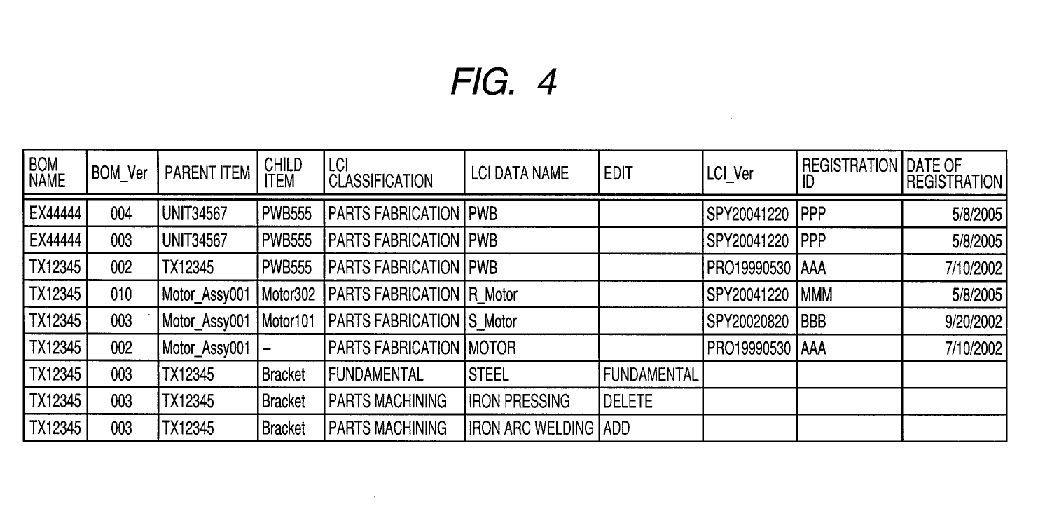

The scenario storage part is described by referring to FIGS. 3 and 4.

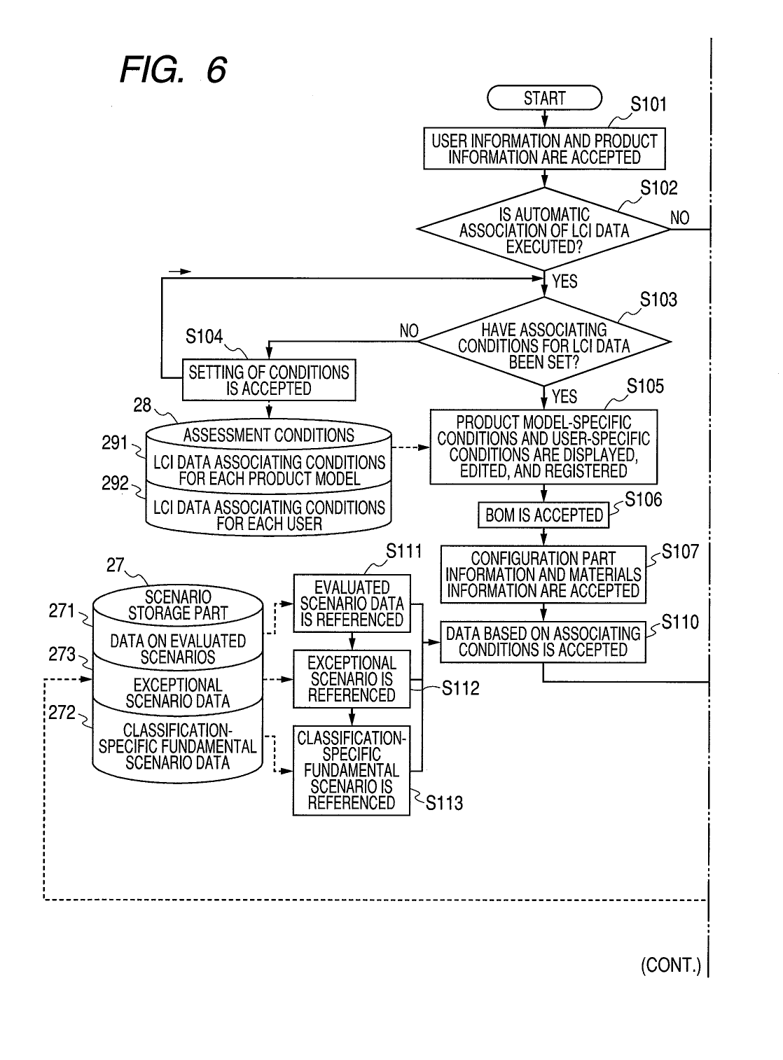

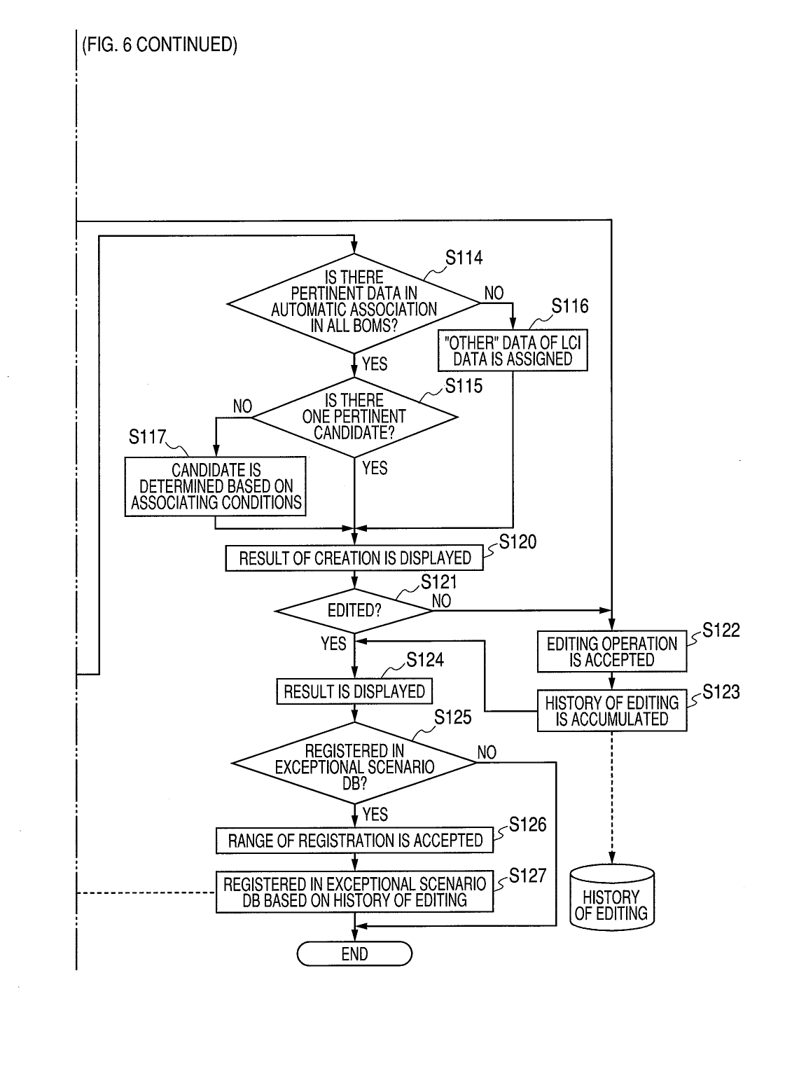

The scenario storage part is made up of an evaluated scenario data storage part 271 in which evaluated data are stored, a classification-specific fundamental scenario storage part 272, and an exceptional scenario data storage part 273 (refer also to FIG. 6). An example of a set of scenario data defined in the classification-specific fundamental scenario storage part 272 is shown in FIG. 3. Product classifications, parts classifications, materials classifications, LCI classifications, and LCI data names are stored. Keywords (keywords 1) regarding parts names, keywords (keywords 2) regarding materials names, and refined search conditions such as district of manufacture are also stored. For example, where the product classification is TV and the materials classification is aluminum, the scenario data is defined in such a way that “aluminum” is adopted in the materials fabrication stage, “aluminum pressing” and “aluminum cutting” are adopted in the parts machining stage, and “aluminum material” is adopted in the recycling stage. “*BRKT*” (where * represents an arbitrary character string) is shown as an example of keywords 1 used in the refined search conditions. Under the above conditions and, at the same time, where the parts names include “BRKT”, application is made. “Keywords 2” and “district” have similar meanings. In this way, regarding product classifications, parts classifications, and materials classifications, a set of scenario data is defined such that general LCI data sets are associated.

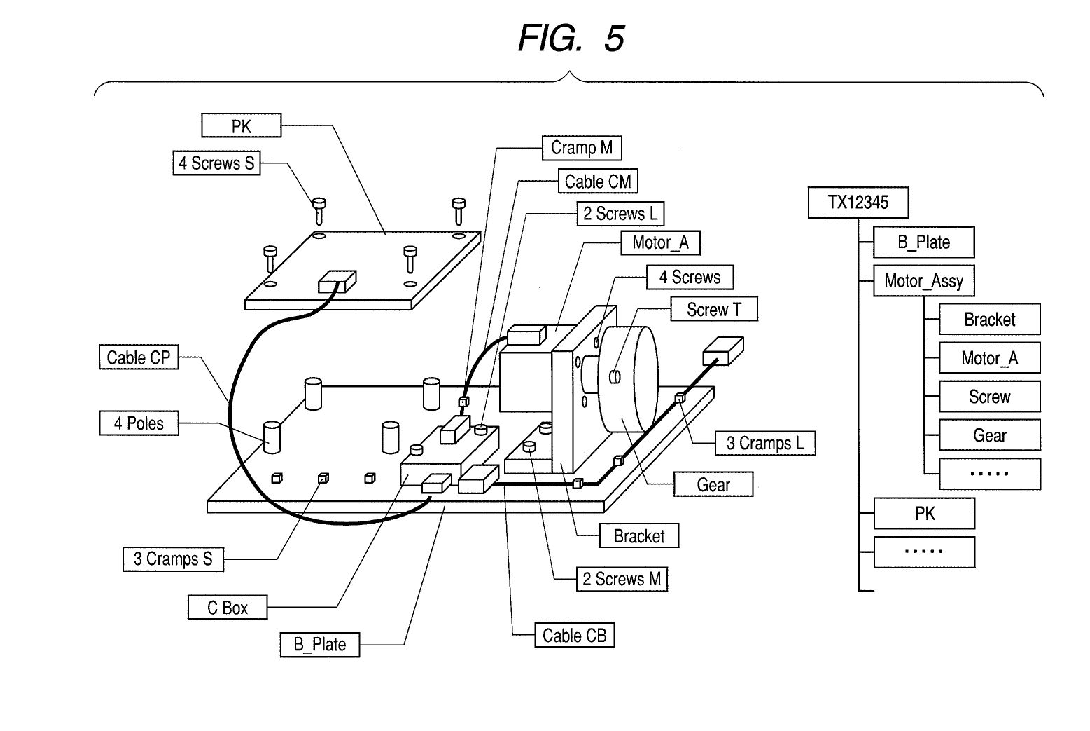

The results of automatic association of BOM and LCI data or the results of LCA (Life Cycle Assessment) are stored in the exceptional scenario storage part 273. Where a user has determined that the classification-specific fundamental scenario is inappropriate and association of LCI data has been modified, the results of the association (results of modification) are also stored in the storage part 273. An example of the exceptional scenario storage part is shown in FIG. 4. A schematic diagram of an example of parts configuration associated with FIG. 4 is shown in FIG. 5. A perspective view and parts names are shown in the left portion of FIG. 5. An example of hierarchy of parts configuration is shown in the right portion. For example, it is shown that parent item “Motor_Assy” is composed of plural child items including “Bracket” and “Motor_A”.

Stored in the exceptional scenario storage part are BOM names (top codes of item codes), version of the BOM, parent item names, child item names, LCI classifications, LCI data names, LCI data versions, IDs of registrants, and dates of registrations. Association of item codes and LCI data versions is stored for each BOM version. Furthermore, where data has been read in based on the classification-specific fundamental scenario and the fundamental scenario has been modified, the fundamental data read in and archival records of the modifications are stored in the exceptional scenario storage part such as the examples of “fundamental”, “delete”, and “add” put in the column of “edited flag”.

Assessment conditions for the individual product models and the individual users, respectively, regarding data to be referenced when the present assessment is made and priority order are stored in the assessment condition storage part 28.

The computing portion 3 has an assessment condition-accepting part 31, a configuration tree display processing part 32, an alternative plan acceptance and integrated configuration tree display processing part 33, an LCI data registration processing portion 34, and an environmental impact assessment (EIA) processing part 35. The computing portion displays the accepted parts configuration tree (including display of the result of edit done by the user from any input-output portion), registers LCI data regarding the configuration tree, performs processing for association, analyzes LCI data related to the BOM, and performs processing for environmental impact assessment, based on the results of the settings of the assessment conditions. In addition, the computing portion accepts an integrated configuration tree including alternative plans, displays plural configurations as configuration trees, and displays the results of assessments when the alternative plans are adopted, together with the results of association of LCI data items and processing of the assessments.

In the assessment condition-accepting part 31, referenced data items and their priority order are defined. At this time, the previously set assessment conditions are managed by the assessment condition storage part 28 and so it is not necessary to reset the conditions after the first setting operation unless a modification is made. Furthermore, common assessment conditions are used for one product model.

The configuration tree display processing portion 32 displays the BOM read in, LCI data, added inputs, and edited data.

The alternative plan acceptance and integrated configuration tree display processing part 33 accepts alternative plans of parts configuration from various departments, alternative plans of process flow, and so on, and displays plural alternative plans in the BOM.

The LCI data registration processing portion 34 searches the storage portion 2 for LCI data regarding parts classification and materials classification, extracts LCI data items, and associates them with the BOM, based on the set assessment conditions.

The environmental impact assessment processing part 35 performs LCA including inventory analysis and impact assessment based on the registered LCI data, and outputs the results.

The environmental impact assessment and design support system of the structure described above is based on a general computer system having a CPU, a memory, an external storage such as an HDD, a reader for reading data from a storage medium such as a CD-ROM, input devices such as a keyboard and a mouse, output devices such as a monitor and a printer, a communication device for connection with a network, and a bus interconnecting these devices. The assessment and design support system can be achieved by causing the CPU to execute a program loaded in the memory. The program may also be downloaded into the external storage either from the storage medium via the reader or from the network via the communication device, loaded into the memory, and executed by the CPU. Still alternatively, the program may be directly loaded into the memory without via the external storage and executed by the CPU. In this case, a memory or external storage is used as the storage portion 2. A reader, an input device, an output device, and a communication device correspond to each input-output portion 1. As shown in FIG. 1, the present system can be manipulated by plural users via the network.

Processing for associating the BOM with LCI data is next described by referring to FIGS. 6-12.

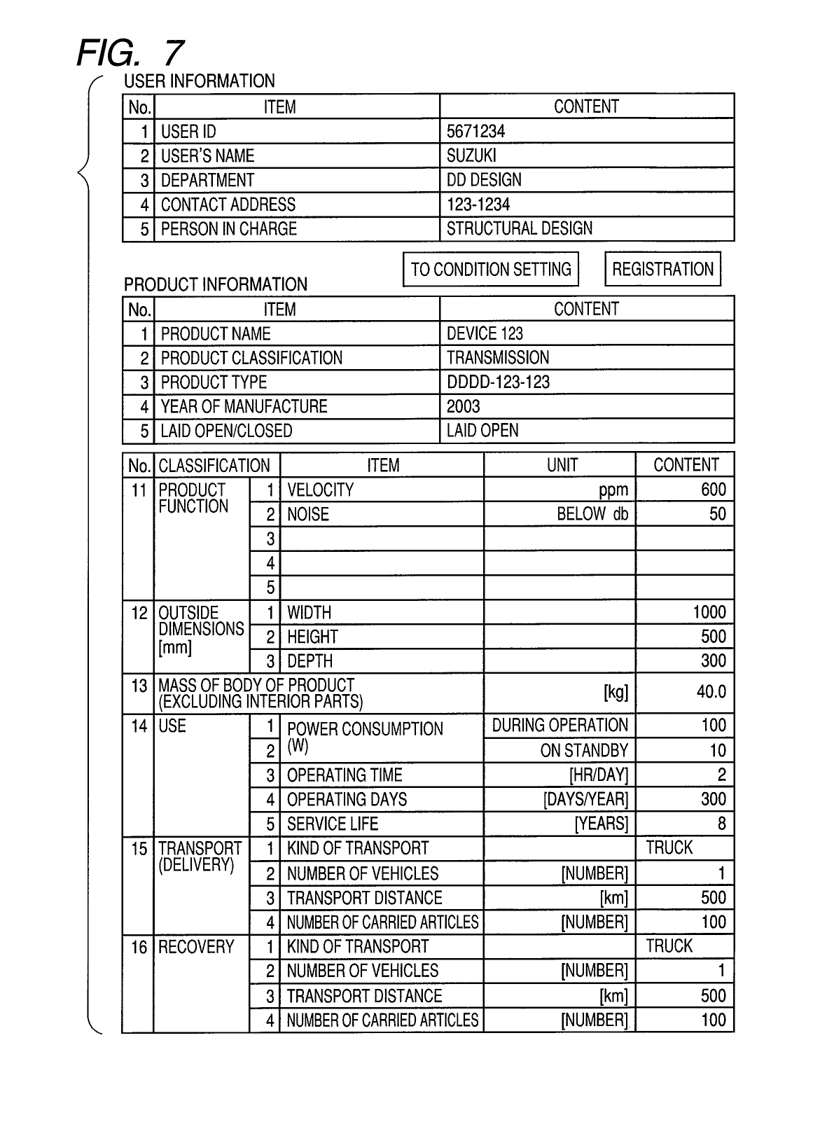

First, user information and product information for executing an LCA are accepted (S101). An example of the display screen is shown in FIG. 7. User ID, user name, belonging department, and a person in charge which are pieces of user information are set. If the user ID is entered, the other information may be extracted from the company/department information storage part 21 and displayed. Regarding product information, various items including product name, product classification, product type (product model), year of production, functions of product, outside dimensions, mass of product body, specifications associated with usage stage, method of transport associated with transport stage, and method of recovery associated with recovery stage are set. At this time, a product classification is selected from a pull-down menu depending on defined list values. Items to be displayed for each product classification are previously set. Product classifications are defined. Consequently, items of the column of product functions and items of usage stage are set. The contents entered into the items “use”, “transport”, and “recovery” are data items used for calculations of LCA in each stage.

If an instruction for executing automatic association of LCI data is then accepted (S102), processing for checking whether or not the associating conditions have been already set is first performed. The assessment condition storage part 28 manages the associating conditions by classifying them into (1) product model-specific LCI data associating conditions 291 that are common to product classifications and (2) user-specific LCI data associating conditions 292 different among user IDs. The assessment condition storage part 28 is searched based on user IDs and product classifications entered as user information and product information. If the conditions have been set, a reference is made and a display is provided (S105). If the conditions have not been set, user's set conditions are stored in the user-specific LCI data associating conditions (S104). A method of displaying the condition settings consists of displaying a separate display screen responsive to “condition setting” button displayed on the product information display screen of FIG. 7. The product model-specific LCI data associating conditions are common to all product models and cannot be modified by individual users. They are managed by a product model manager or other person who has administrator rights. Where a modification is made, the conditions are registered in the user-specific LCI data associating conditions. The contents of the modification are stored in the user-specific LCI data associating conditions 292 using the “registration” button of FIG. 7.

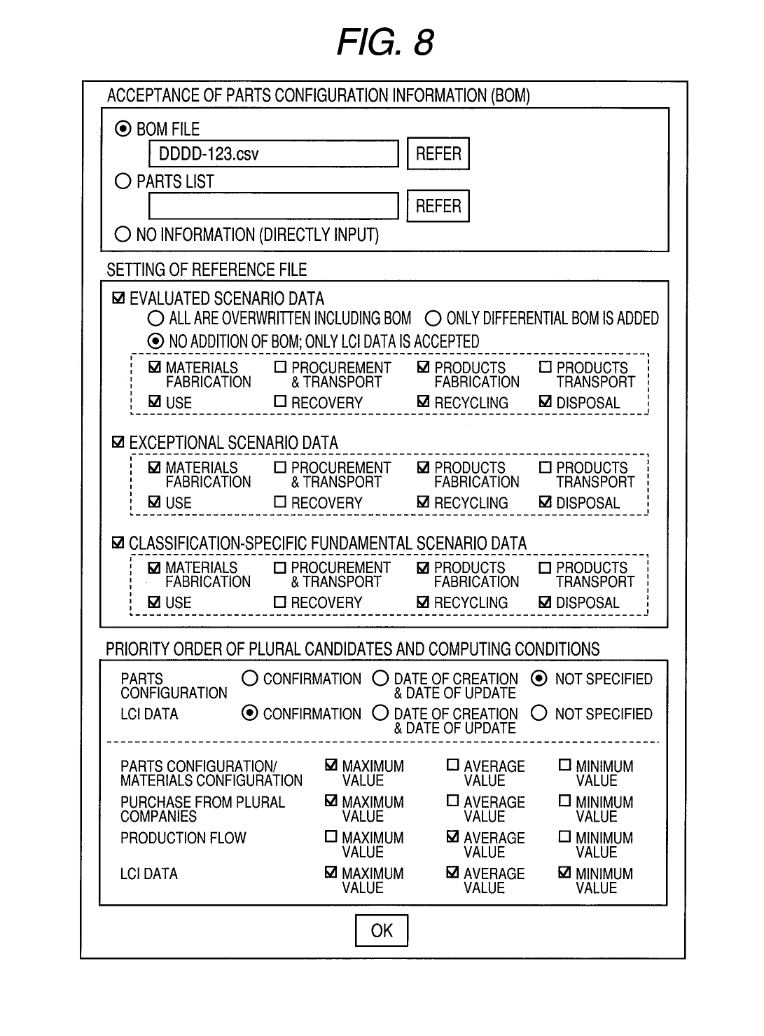

A screen for setting LCI data associating conditions is displayed using the “condition setting” button of FIG. 7. An example of the setting screen is shown in FIG. 8. As shown in FIG. 8, three major conditions are set. First, a setting is made to accept parts configuration information (BOM). An example in which a file has been specified has been shown. Alternatively, an interface with a database such as a PDM database may be built, and data may be automatically accepted by specifying item codes or the like. In addition, data may assume the form of a parts list having no hierarchical information.

Secondly, a referenced file is set (i.e., associating conditions are set). Here, reference conditions are set for evaluated scenario data in which previously evaluated data have been accumulated, exceptional scenario data in which different scenarios have been stored for different BOM versions, and classification-specific scenario data in which a standard scenario has been defined for each individual classification. As shown in the example, with respect to evaluated scenario data, settings are made to overwrite all designed BOMs at the time of evaluation including past parts configurations, to add differential parts configuration, or to add only LCI data. Furthermore, in the present example, life cycle stages include materials fabrication, procurement and transport, product manufacturing (parts manufacturing, parts machining, product manufacturing, and so on), products transport, use, recovery, recycling, and disposal. A setting is made to determine to what of the stages is a reference made; then information is accepted from the determined stage.

Thirdly, conditions are set for computing performed when plural candidates are produced where the processing for associating LCI data is performed. First, a parts configuration and a set of LCI data are selected from plural candidates. For this selection, an order of priority is selected from “presence/absence of confirmed information”, “date of newest update”, and “no priority order”. In the illustrated example, any parts configuration is not specified. With respect to LCI data, if there is “confirmed” information, priority is placed on the information. If there is no confirmed information, the setting is the same as the setting “no priority order”.

Where there are plural candidates, there are four major cases. In the first case, the design department has plural plans of parts configuration. For example, there are alternative plans or there are different client specifications. In the second case, the materials department purchases from plural companies. Plural purchased articles are associated with one item code. In the third case, the manufacturing department has plural plans of parts and materials manufacturing process flow. In the fourth case, there are plural LCI data items for one part or one material. There are plural choices. Computing conditions are set for these four kinds of cases. As shown in the figure, at least one of maximum value, average value, and minimum value is set. Based on the above-described settings, steps S106, S107, S110 (S111, S112, and S113) are executed in the processing of FIG. 6.

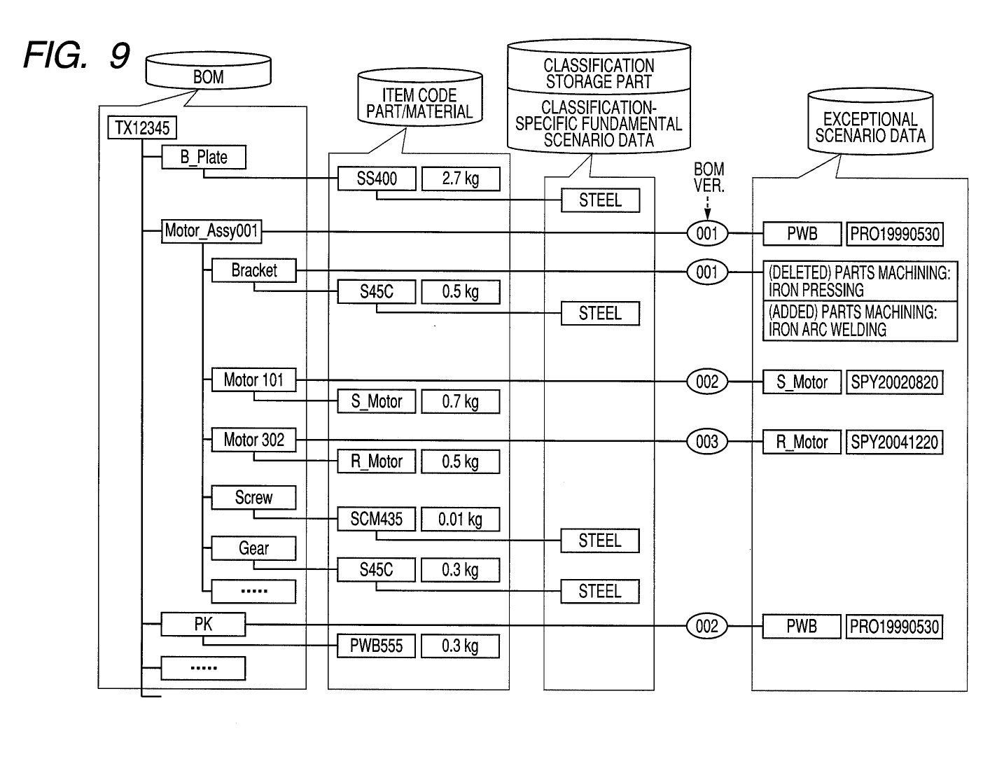

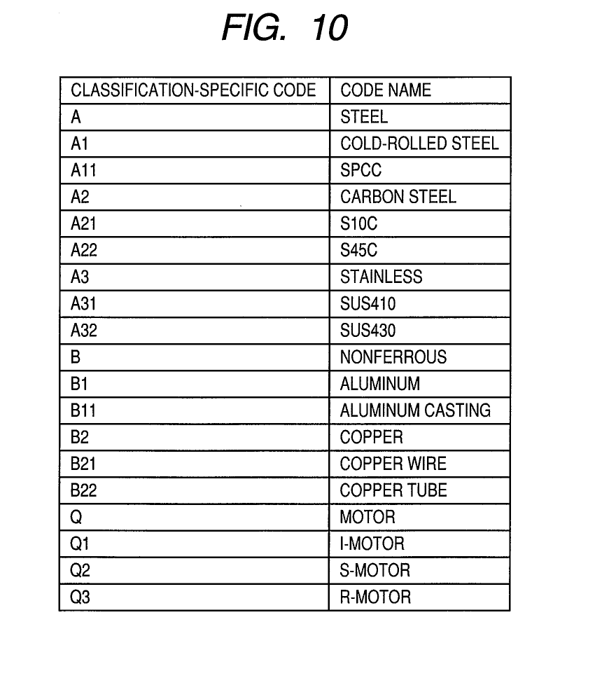

Association is now described summarily by referring to FIG. 9. In the present example, BOM versions 1 to 3 are collectively shown. Associating conditions are examples in which exceptional scenarios and classification-specific fundamental scenarios are referenced. The exceptional scenarios of FIG. 3 and classification-specific scenarios of FIG. 4 are referenced. Because of the processing of S106 and S107 of FIG. 6, information about the purchased parts and kinds and masses of materials are associated with item codes in the designed BOM from the database. Items of LCI data coincident in BOM version and parts and materials information with the configuration information in the BOM are accepted by referring to the exceptional scenarios (S110). Then, items of LCI data which are coincident in information about parts and materials are referenced by referring to the classification-specific fundamental data (S113). Often, the codes of parts and materials treated by designed BOMs are different from the codes of parts and materials managed by the LCI data. Therefore, the codes of parts and materials are converted into codes of LCI data using the conversion table (classification storage part 25) shown in FIG. 10, thus facilitating the association. As in the illustrated example of “Bracket”, higher priority is given to exceptional scenarios. Therefore, even if materials are the same as those given by data referenced in exceptional scenarios, data about the classification-specific fundamental scenarios are not referenced.

Processing starting with step S114 of FIG. 6 is next described. If no pertinent LCI data is found in the BOM configuration during the processing for automatic association of LCI data, “other” data is assigned (S116). If there are plural candidates for LCI data, the priority order of the candidates is determined based on the previous priority order conditions and calculational conditions from the date at which the LCI data was created and from various conditions including confirmed information (S117). The results of the creation are displayed (S120). After the automatic association of the LCI data, editing is done if necessary (S121). At this time, the history of editing is accumulated in the editing history database (S122 and S123).

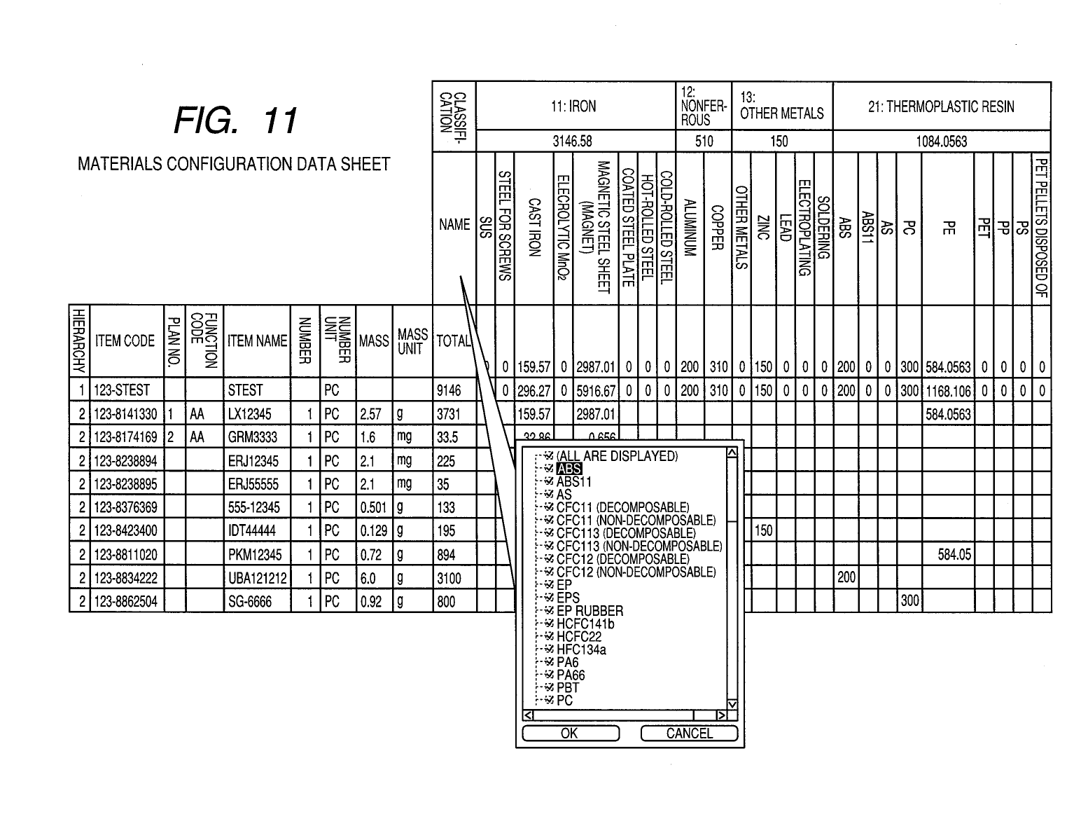

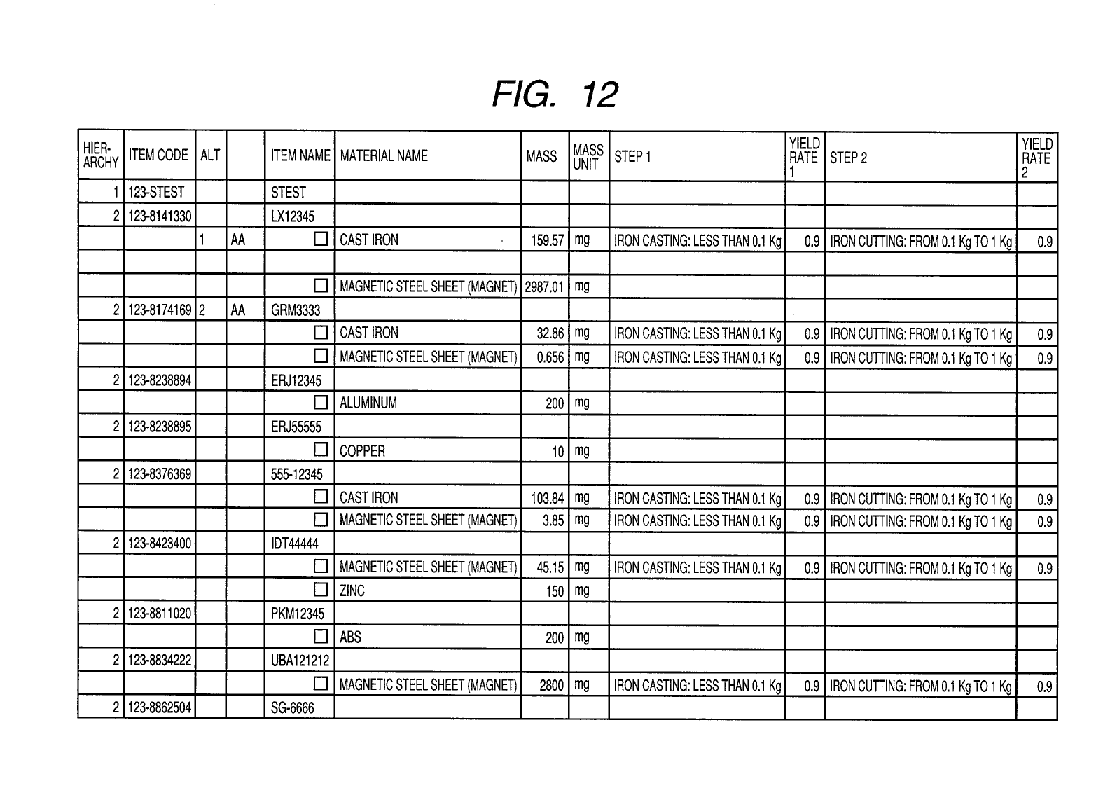

An example of result of the creation and an example of editing screen are described by referring to FIGS. 11 and 12. FIG. 11 shows an example of the result of association of the materials configuration. FIG. 12 shows an example of result of association of production process.

FIG. 11 is a table showing two kinds of data. BOM, i.e., parts configuration, is plotted on the vertical axis of the table. LCI data names are given along the horizontal axis. BOM information arranged along the vertical axis includes hierarchical level, item code, ALT-No. (alternative plan No.), function code, item name, number, and mass. In the illustrated example, the LCI data name given along the horizontal axis is distinguished from classification name. It is possible to provide plural classifications, e.g., major classification and middle classification. Each mass is displayed at the intersection of the two axes. As shown, total values are displayed in the column and row at the edges of the intersections. In the BOM, the total amounts are accumulated at each hierarchical layer. With respect to LCI data, a total value is displayed for each classification. In the present sheet, editing is done regarding the parts configuration and materials configuration. The result is associated with LCI data about the materials fabrication stage.

Where editing is performed, a manipulation is performed. For example, a value or a part name is modified or an item code (row of the part) is added. With respect to LCI data items, a check box is displayed to prompt the user to narrow down items to be displayed if the button of the column “name” is clicked, for example, as shown. A refined display can be provided by making a choice. The same principle applies to “classification”.

In the table of FIG. 12 showing both BOM and manufacturing process flow, the vertical axis is the same as that of FIG. 11. The manufacturing process flow is displayed on the horizontal axis. LCI scenarios referenced regarding parts or materials are displayed. Where editing is done, LCI data names such as product manufacturing stage and disposal stage are displayed by a pull-down menu. Editing is enabled if a choice is made.

Editing is done according to the need, for example, as in the examples of FIGS. 11 and 12. The results including the result of editing are displayed (S124). The edited data is prompted to be registered into an exceptional scenario database (S125). In the editing screen, a flag is set when a manipulation is performed. Edited items and data items already stored in the exceptional scenario database are checked. A range to be registered is displayed. Setting of the registered range is accepted (S126). Based on the history of editing of the selected item codes, the edited data items are registered into the exceptional scenario database (S123). If the editing is judged to be unnecessary, data about LCA (Life Cycle Assessment) may be immediately automatically created. The LCA may be executed and the result may be outputted.

A method of accepting and evaluating improved design plans offered by plural departments and plural persons in charge by the use of the environmental impact assessment and design support system according to the present invention is described next by referring to FIGS. 11 and 12. When LCI data is associated with the BOM as described previously, it is conceivable that there are plural candidates in four major cases: (1) alternative to a parts configuration plan of a design department; (2) purchase by the materials department from plural companies; (3) a plan of manufacturing process flow by the manufacturing department; and (4) plural sets of LCI data. In the present embodiment, examples of (1) and (3) are described below.

One product model is designed in such a way that a different designer is assigned to each different unit or to a different task such as design of a structure or electrical circuitry. The designers discuss plural plans to achieve continual improvement of the environmentally friendly design and to satisfy cost and functional requirements. Furthermore, depending on clients, some functions may be added, deleted, or modified to or from the fundamental configuration. It is assumed that the design department has some plans of configuration about one product model. Similarly, the manufacturing department is required to manufacture products at lower costs and with reduced environmental load. In addition, some plans are discussed to determine what key manufacturing plant is used or what process flow is used to manufacture one part. Therefore, in the manufacturing process flow, it is also assumed that there are plural plans.

Processing for associating LCI data with the BOM designed to hold plural plans of parts configuration and materials configuration and plural plans of the manufacturing process flow about such product model is performed.

FIGS. 11 and 12 show the results of the processing for associating the LCI data. FIG. 11 shows an example in which plural plans of plural parts configurations and plural plans of materials configurations are displayed regarding the BOM. FIG. 12 shows an example in which plural plans of the manufacturing process flow are displayed for the same BOM.

Plural plans of items having the same item code are displayed regarding parts or parts units having the same functions (having the same function code), using the ALT-No. (alternative plan code No.) and function codes shown in FIG. 11. In the table of FIG. 12 showing both BOM and manufacturing process flow, plural manufacturing process flows are displayed for the same part or same material. In response to the plural plans, the results of evaluation are outputted based on the assessment conditions shown in FIG. 8.

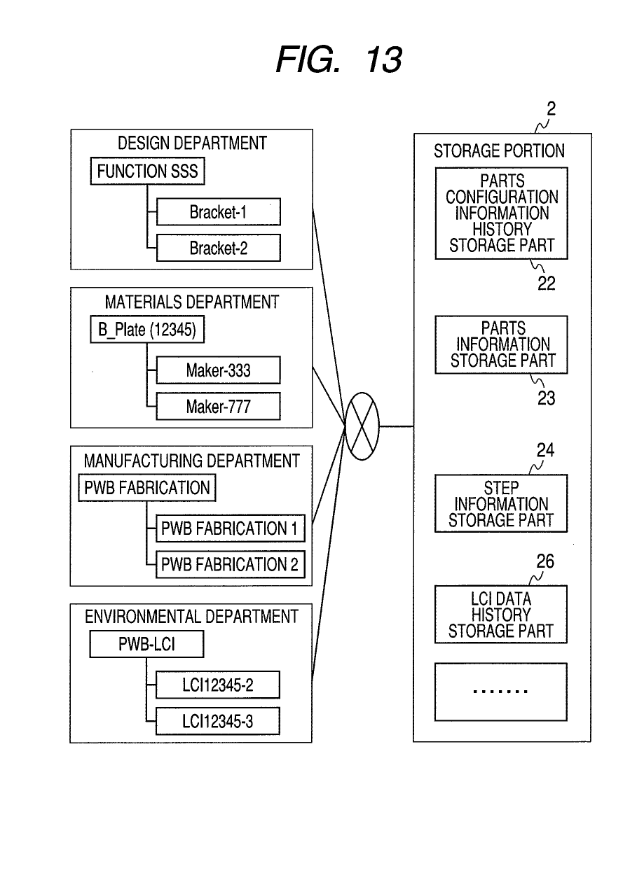

Registration of plural alternative plans from departments and the processing performed by the environmental impact assessment and design support system to accept the plans are next described summarily by referring to FIG. 13. As shown in FIG. 13, the design department discusses plural plans of parts configurations for the same function and manages the design plans by PDM (product data management) and the like. The materials department manages information about plural suppliers or manufacturers regarding one part specification (item code). The manufacturing department discusses plans of manufacturing process flow which may or may not include domestic and overseas key manufacturing plants for each manufacturing process sequence, taking account of manufacturing of some products. Additionally, the environmental department manages LCI data about purchased parts and LCI data about the in-house manufacturing department. The management includes confirmation of information such as data confirmation. These alternative plans by the departments are stored into the parts configuration information history storage part 22 regarding information about the parts configuration through a communication means such as an intranet or the Internet. Information about the purchased parts is stored into the parts information storage part 23. Information about the manufacturing process is stored in the step information storage part 24. LCI data is stored into the LCI data history storage part 26. LCA (Life Cycle Assessment) can be performed including plural alternative plans by associating the LCI data with the BOM based on the results and on the flow of FIG. 6.

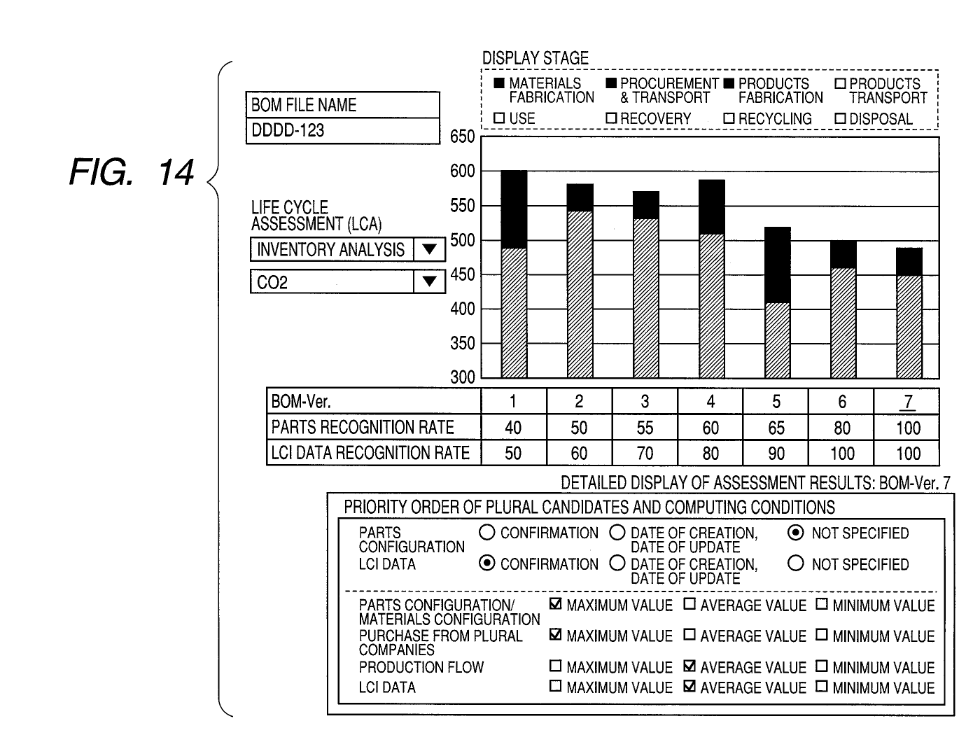

An example of analysis of assessment results is shown in FIG. 14. The transition of BOM version, i.e., design history, is plotted on the horizontal axis. An environmental load item CO₂ of inventory analysis is selected as an example of LCA results and plotted on the vertical axis. In the present example, assessment results are accumulated continually from the initial phase of design based on the assessment conditions described in FIG. 8. The displayed environmental load item can be selected from a pull-down menu or the like. An example of the amount of exhausted CO₂ is shown. Together with the design history, the rates of confirmation of parts at that instant of time and the rates of confirmation of LCI data are displayed. The information about the confirmation of the LCI data is the result of a reference made to the LCI data table having archival records shown in FIG. 2. In the present example, the stages of materials manufacturing, procurement and transport, and product manufacturing are displayed. Room left for improvements of various departments can be displayed by limiting the displayed stages only to the manufacturing stage such that the provided display is adapted for the manufacturing department. Display of stages of the manufacturing department is limited to the materials manufacturing stage or parts manufacturing stage, whereby the provided display is adapted for the materials department or parts design. The design histories shown in this figure are linked to the detailed assessment results of BOM versions. Assessment conditions are displayed by selecting a BOM version. Also, the results of the assessment are displayed. The foundations of the environmentally friendly design can be accumulated by storing LCI data in which BOM histories are associated, together with assessment results for each BOM version in this way.

What is claimed is:

1. A design support system for supporting an environmental impact assessment of a product made up of plural parts, the assessment being conducted at a stage of design to assess the environmental impact of the product through the life cycle of the product, said design support system comprising:
an input-output portion for accepting instructions from users and displaying information to the users;
means interfaced with a design system that designs the product;
an LCI data history storage portion for storing LCI data histories made up of data records in which at least parts classifications, materials classifications, process classifications, and amounts of environmental load are defined in each stage of the life cycle, the data records including identification information for identifying items of data registered, the identification information including at least identification codes, search periods, search regions, and dates of creation;
a parts configuration information history storage portion in which archival records of updating of information about parts configuration during a design process are accumulated; and
an arithmetic portion for managing both said information about the parts configuration and said LCI data while associating their histories with each other, performing processing for referencing the associated LCI data when an environmental impact assessment of said information about the parts configuration is conducted, and performing processing for extracting and outputting updated data items of said LCI data.

2. A design support system for supporting an environmental impact assessment of a product made up of plural parts, the assessment being conducted at a stage of design to assess the environmental impact of the product through the life cycle of the product, said design support system comprising:
an input-output portion for accepting instructions from users and displaying information to the users;
means interfaced with a design system that designs the product;
an LCI data history storage portion for storing LCI data histories made up of data records of information defining an amount of environmental load in each stage of the life cycle (LCI classification) and for each of LCI data item name, the data records including data items about at least identification codes, dates of creation, versions of creation, searching company codes, search periods, search regions, and methods of search;
a parts configuration information history storage portion in which archival records of updating of information about parts configuration during a design process are accumulated;
in-house department information storage portion for storing information about in-house departments including at least design department, materials department, and manufacturing department;
a company information storage portion holding information about at least parts suppliers, clients to which products are delivered, and associated key manufacturing plants;
a parts information storage portion in which fundamental information about product configuration is stored, said fundamental information including information about specifications of parts, classifications, and materials configuration and information about contained substances;
a step information storage portion in which information about process steps for manufacturing parts and products is stored; and
an arithmetic portion for performing processing for accepting a parts configuration tree obtained by integrating alternative plans presented by company departments and companies and converting the tree into a parts configuration tree for an assessment, processing for displaying the parts configuration tree, processing for registering LCI data while associating the LCI data with the parts configuration tree, processing for conducting an environmental impact assessment in which the LCA (Life Cycle Assessment) is computed based on the LCI data, and processing for outputting results of the parts configuration tree obtained by integrating the plural alternative plans.

3. A design support system for supporting an environmental impact assessment of a product made up of plural parts, the assessment being conducted at a stage of design to assess the environmental impact of the product through the life cycle of the product as set forth in claim 2, wherein said arithmetic means further operates to store and manage a plan adopted during a design process as a history of the information about the parts configuration and to cause a configuration tree display-and-processing portion to display the plan together with the history of adoption.
